(19) United States
(12) Patent Application Publication
(10) Pub. No.: US 2009/0292072 A1
(43) Pub. Date: Nov. 26, 2009

(54) Use of nonionic surfactants as emulsifiers for emulsion polymerization

(75) Inventors: Ronald Klagge, Erkrath (DE); Markus Scherer, Koln (DE); Thomas Schliwka, Bergisch-Gladbach (DE); Katharina Homberg, Hilden (DE); Uwe Held, Velbert (DE); Thomas Mausberg, Haan (DE)

Correspondence Address: FOX ROTHSCHILD LLP, 2000 MARKET STREET, PHILADELPHIA, PA, 19103, US

(73) Assignee: COGNIS IP MANAGEMENT GMBH, Duesseldorf (DE)

(21) Appl. No.: 12/469,226

(22) Filed: May 20, 2009

(30) Foreign Application Priority Data
May 20, 2008 (EP) EP/08009227.3

(51) Int. Cl. C08F 2/22

(52) U.S. Cl. 524/811; 524/800; 524/804; 524/832; 524/836

(57) ABSTRACT

Disclosed is the use of nonionic surfactants as emulsifiers for emulsion polymerization, one or more nonionic surfactants being selected from the group consisting of
(a) addition products of from 1 to 40 mol of ethylene oxide and/or propylene oxide per mole onto allyl alcohol, and
(b) addition products of from 1 to 40 mol of ethylene oxide and/or propylene oxide per mole onto allyl alcohol, where the OH group of these addition products is terminally capped in the sense that it is replaced by a group OR, where R is an alkyl group having 1 to 20 carbon atoms which may be saturated or unsaturated, straight-chain or branched.

### CROSS-REFERENCE TO RELATED APPLICATIONS

The present application is related to and claims the priority benefit of European Patent Application No. EP/08009227.3 filed on May 20, 2008 which is incorporated herein by reference in its entirety

### FIELD OF THE INVENTION

The invention relates to the use of special low-foam surfactants as emulsifiers for emulsion polymerization, and also to the low-foam polymer dispersions which can be prepared using these surfactants and also to a method of producing these low-foam polymer dispersions.

### BACKGROUND OF THE INVENTION

Emulsion polymerization is a special method of polymerization in which monomers with low solubility in water are emulsified in water with the help of emulsifiers and, by using water-soluble initiators such as potassium peroxodisulfate or redox initiators, are polymerized. Anionic and/or nonionic surfactants are essential constituents. Via the formation of micelles in aqueous solution, they ensure the process of emulsion polymerization.

In the course of emulsion polymerization processes, considerable foam formation generally occurs, particularly after the end of the polymerization process, when unreacted residual monomer is removed by stripping off in vacuo. In order to effectively control this—in most cases undesired—foam, i.e. to agitate it to rapidly disintegrate, antifoams are often used, although these affect the quality of the resulting latex.

### DETAILED DESCRIPTION OF PREFERRED EMBODIMENTS

The object of the present invention was to provide compounds which (alone or in a mixture with other compounds) are suitable as emulsifiers for emulsion polymerization. When used as emulsifiers for emulsion polymerization, these compounds should in particular allow only slight coagulate formation to take place.

A further object which was to be achieved by the emulsifiers of the invention was to effectively control foam which arises in the course of emulsion polymerization processes, which in particular is to be understood as meaning that the foam which does arise disintegrates rapidly. In addition, foam which often occurs after the end of the polymerization process in an undesired manner when unreacted residual monomer is removed by stripping off in vacuo, should be controlled by the emulsifiers of the invention.

The present invention firstly provides the use of nonionic surfactants as emulsifiers for emulsion polymerization, wherein one or more nonionic surfactants are selected from the group consisting of
(a) addition products of from 1 to 40 mol of ethylene oxide and/or propylene oxide per mole onto allyl alcohol, and
(b) addition products of from 1 to 40 mol of ethylene oxide and/or propylene oxide per mole onto allyl alcohol, where the OH group of these addition products is terminally capped in the sense that it is replaced by a group OR, where R is alkyl having 1 to 20 carbon atoms which may be saturated or unsaturated, straight-chain or branched.

The present invention further provides a method of producing aqueous latices by emulsion polymerization, where the emulsifiers used are one or more surfactants selected from the group consisting of
(a) addition products of from 1 to 40 mol of ethylene oxide and/or propylene oxide per mole onto allyl alcohol, and
(b) addition products of from 1 to 40 mol of ethylene oxide and/or propylene oxide per mole onto allyl alcohol, where the OH group of these addition products is terminally capped in the sense that it is replaced by a group OR, where R is alkyl having 1 to 20 carbon atoms which may be saturated or unsaturated, straight-chain or branched.

In one embodiment of the method according to the invention, besides the one or more surfactants from the group of compounds (a) and (b), one or more additional surfactants are selected from the group consisting of
(c) compounds of the formula R¹—O—X—R², where X is a moiety which is composed of 1 to 40 ethylene oxide and/or propylene oxide units linked together and in which R¹ and R², independently are alkyl having 1 to 20 carbon atoms which may in each case be saturated or unsaturated, straight-chain or branched, with the proviso that R¹ and R² are not allyl,
(d) compounds of the formula R³—O—X—H, where X is a moiety which is composed of from 1 to 40 ethylene oxide and/or propylene oxide units linked together and in which R³ is alkyl having 1 to 20 carbon atoms which may be saturated or unsaturated, straight-chain or branched, with the proviso that R³ is not allyl, and
(e) compounds of the formula H—O—X—H, where X is a moiety which is composed of 1 to 40 ethylene oxide and/or propylene oxide units linked together.

Compounds (a) to (e) in each case comprise a moiety which is composed of 1 to 40 ethylene oxide units (EO) and/or propylene oxide units (PO) linked together. This moiety can be composed either exclusively of EO units or exclusively of PO units. However, it is also possible for it to consist both of EO units and of PO units; in this case, the EO and/or PO units may be distributed randomly or blockwise. The synthesis of the compounds (a) to (e) can be accomplished by methods known in the art. In particular, the customary techniques of ethoxylation and/or propoxylation are applicable for inserting the EO/PO moiety. These generally take place at elevated temperature and increased pressure in the presence of suitable alkoxylation catalysts. The choice of alkoxylation catalyst influences the so-called homolog distribution. Thus, in the presence of catalytically effective alkali metal alcoholates such as sodium methylate, a broad homolog distribution is achieved, whereas, for example, in the presence of hydrotalcite as catalyst, a considerably narrowed homolog distribution (so-called “narrow range” products) is achieved.

### Compounds (a)

Compounds (a) are addition products of from 1 to 40 mol of ethylene oxide and/or propylene oxide per mole onto allyl alcohol.

### Compounds (b)

Compounds (b) are addition products of from 1 to 40 mol of ethylene oxide and/or propylene oxide per mole onto allyl alcohol, where the OH group of these addition products is terminally capped in the sense that it is replaced by a group OR, where R is alkyl having 1 to 20 carbon atoms which may be saturated or unsaturated, straight-chain or branched.

### Compounds (c)

Compounds (c) are compounds of the formula R¹—O—X—R², where X is a moiety which is composed of 1 to 40 ethylene oxide and/or propylene oxide units linked together and where R¹ and R², independently are alkyl having 1 to 20 carbon atoms which may in each case be saturated or unsaturated, straight-chain or branched, with the proviso that R¹ and R² are not allyl.

### Compounds (d)

Compounds (d) are compounds of the formula R³—O—X—H, where X is a segment which is composed of 1 to 40 ethylene oxide and/or propylene oxide units linked together and in which R³ is alkyl having 1 to 20 carbon atoms which may be saturated or unsaturated, straight-chain or branched, with the proviso that R³ is not allyl.

### Compounds (e)

Compounds (e) are compounds of the formula H—O—X—H, where X is a segment which is composed of 1 to 40 ethylene oxide and/or propylene oxide units linked together.

The compounds from group (a) and/or (b) to be used according to the invention, optionally further in combination with compounds from group (c), (d) and/or (e), can be used as the sole emulsifiers (primary emulsifiers) during the emulsion polymerization. However, it is also possible to use them together with one or more anionic, cationic or other nonionic emulsifiers different from compounds (a) to (e).

In a preferred embodiment, the nonionic emulsifiers according to the invention are used in combination with anionic emulsifiers known to the person skilled in the art, in particular those selected from the group consisting of fatty alcohol sulfates, fatty alcohol ether sulfates, sulfosuccinates, alkylarylsulfonates, alkyl aryl ether sulfates, alkyl sulfates, fatty acid sulfonates, phosphate esters, olefin sulfates, alkanesulfonates, and α-sulfomonocarboxylic acid esters.

The emulsifiers of group (a) and/or (b), optionally in combination with compounds from group (c), (d) and/or (e), are used in the emulsion polymerization in an amount of from 0.5 to 10% by weight, preferably from 1 to 5% by weight and in particular from 1 to 3% by weight, based on the total amount of the monomers used during the emulsion polymerization.

It may, however, also be desired to carry out the emulsion polymerization in the presence of other emulsifiers, which are selected in particular from the group of nonionic and/or anionic surfactants, and to meter in one or more emulsifiers of group (a) and/or (b), optionally in combination with compounds from group (c), (d) and/or (e), to the finished latices only after the polymerization is complete, where they then act to stabilize the aqueous lattices after formation (poststabilization).

In a further embodiment, the compounds of group (a) and/or (b), optionally in combination with compounds from group (c), (d) and/or (e), are used both during the emulsion polymerization and also after the emulsion polymerization. In this connection, it may be desired to use the compounds of group (a) and/or (b), optionally in combination with compounds from group (c), (d) and/or (e), in a mixture with other surfactants, or as the sole surfactants. In one variant, the emulsion polymerization is started in the presence of classic anionic surfactants or mixtures of classic anionic and nonionic surfactants and then one or more emulsifiers of group (a) and/or (b), optionally in combination with compounds from group (c), (d) and/or (e), are used toward the end of the emulsion polymerization and additionally after the polymerization is complete; in this variant, the emulsifiers of group (a) and/or (b), optionally in combination with compounds from group (c), (d) and/or (e), act firstly as emulsifiers during the emulsion polymerization and secondly in the sense of a poststabilization of the aqueous latices.

For the poststabilization, the compounds of group (a) and/or (b), optionally in combination with compounds from group (c), (d) and/or (e), are used, irrespective of whether they have already been used during the emulsion polymerization, in an amount of from 0.1 to 10% by weight, preferably from 0.1 to 5% by weight and in particular from 0.1 to 3% by weight, based on the total amount of the monomers used during the emulsion polymerization.

The nature of the polymers and copolymers in the aqueous latices are not subject per se to any particular restrictions. However, particular preference is given to polymers and copolymers based on the following monomer building blocks: acrylic acid, acrylic acid esters, butadiene, methacrylic acid, methacrylic acid esters, styrene, vinyl acetate and vinyl versatate.

In one preferred embodiment, the surfactants to be used according to the invention as emulsifiers are chosen exclusively from the compounds of class (a).

In a further preferred embodiment, the surfactants to be used according to the invention as emulsifiers are selected exclusively from the compounds of class (b).

The invention further provides aqueous polymer dispersions obtainable by the method according to the invention described above.

### EXAMPLES

Substances used:
FA-30EO: addition product of 30 mol of ethylene oxide onto a fatty alcohol (Disponil LS 30, Cognis)
Breox I: ethylene oxide addition product onto allyl alcohol (Breox AA E 450H, Cognis)
Breox II: polyethylene glycol 400 (Merck)
Disponil A 3065: modified ethoxylated fatty alcohol (Cognis)
Disponil SDS 15: sodium lauryl sulfate (Cognis)

### Example S1

A surfactant mixture was prepared by mixing the following components: 45.5 g of FA-30EO, 19.5 g of Breox 1.35 g of demineralized water. The active substance content of the mixture was 65%.

To test the foaming behavior, a solution with an active substance content of 1% by weight and a content of NaCl of 0.05% by weight was prepared from the aqueous surfactant mixture by dilution with NaCl-containing demineralized water. This solution was tested in a foam testing instrument of the type “R-2000” (Sita) with the following parameters: temperature: 20° C.; stirring time: 3×10 seconds; stirring speed: 1100 revolutions per minute; total measuring time: 20 minutes; measurement time interval: 10 seconds. The table below gives the foam amount (in mm) as a function of the time (in minutes):

| Time [min] | 0 | 2 | 4 | 6 | 8 | 10 | 12 | 14 | 16 | 18 | 20 |
|---|---|---|---|---|---|---|---|---|---|---|---|
| Foam [mm] | 267 | 261 | 196 | 138 | 108 | 89 | 74 | 61 | 53 | 44 | 36 |

### Example S2

A surfactant mixture was prepared by mixing the following components: 45.5 g of FA-30EO, 19.5 g of Breox II, 35 g of demineralized water. The active substance content of the mixture was 65%.

The foam test was carried out as described in Example S1. The table below gives the foam values obtained:

| Time [min] | 0 | 2 | 4 | 6 | 8 | 10 | 12 | 14 | 16 | 18 | 20 |
|---|---|---|---|---|---|---|---|---|---|---|---|
| Foam [mm] | 245 | 242 | 223 | 173 | 138 | 113 | 102 | 90 | 78 | 72 | 65 |

### Comparative Example S3

A foam test with Disponil A 3065 (65% active substance content) was carried out as described in Example S1. The table below gives the foam values obtained:

| Time [min] | 0 | 2 | 4 | 6 | 8 | 10 | 12 | 14 | 16 | 18 | 20 |
|---|---|---|---|---|---|---|---|---|---|---|---|
| Foam [mm] | 257 | 253 | 251 | 248 | 247 | 244 | 241 | 239 | 237 | 235 | 234 |

### Example L1

Using the surfactant mixture according to Example S1, a polymer dispersion (latex) was prepared as follows:

The polymerization reactor was charged with a mixture of 476.2 g of demineralized water, 13.3 g of Disponil SDS 15 and 0.5 g of potassium peroxodisulfate (mixture 1) and 40 ml of a mixture of 140.0 g of ethyl acrylate, 140.0 g of methyl methacrylate, 52.5 g of butyl acrylate and 17.5 g of acrylic acid (mixture 2). The mixture was then flushed with nitrogen for 15 minutes; the nitrogen stream was maintained over the entire reaction time. The reactor was heated to 80° C. Upon reaching a temperature of 70° C., a mixture of 10.0 g of the surfactant mixture according to Example S1 (calculated on the basis of 100% active substance) and 50 g of demineralized water (mixture 3) was added over the course of 5 minutes. The remaining residue of mixture 2 and also a solution of 1.5 g of potassium peroxodisulfate in 98.5 g of demineralized water (mixture 4) is then metered in over the course of 2 hours. When the addition was complete, the mixture was afterpolymerized for 1 hour at a temperature of 83° C., cooled to 30° C. and adjusted to a pH of 8.5 with ammonia.

For the foam test, a solution of 10% of this polymer dispersion in demineralized water was prepared and measured analogously to Example S1. The table below shows the ascertained foam values:

| Time [min] | 0 | 2 | 4 | 6 | 8 | 10 | 12 | 14 | 16 | 18 | 20 |
|---|---|---|---|---|---|---|---|---|---|---|---|
| Foam [mm] | 173 | 92 | 58 | 37 | 25 | 19 | 12 | 9 | 7 | 6 | 5 |

### Comparative Example L2

A solution of 10% Disponil A 3065 in demineralized water was measured analogously to Example S1. The table below gives the ascertained foam values:

| Time [min] | 0 | 2 | 4 | 6 | 8 | 10 | 12 | 14 | 16 | 18 | 20 |
|---|---|---|---|---|---|---|---|---|---|---|---|
| Foam [mm] | 220 | 214 | 211 | 206 | 204 | 199 | 197 | 193 | 191 | 187 | 181 |

### Properties of the Latices

The use of the emulsifiers according to Examples S1 and S2 had no negative effects at all on the properties of the latices prepared using them in the emulsion polymerization. This was true irrespective of the nature of the monomers used for the polymerization. In particular, acrylate, styrene/acrylate and VeoVa monomer systems were tested.

Moreover, the foam behavior described in more detail above (see Example L1 and Comparative Example L2) was confirmed also when using the emulsifiers to be used according to the invention in emulsion polymerization. Whereas the emulsifiers according to Examples E1 and E2 have an excellent foaming behavior (with rapid subsidence profile), when using the emulsifier Disponil A 3065, marked foaming was observed, with the foam remaining at an approximately constant high level for the duration of the entire 20-minute measuring time.

Furthermore, it was observed that the polymer dispersions prepared using the surfactant mixtures according to the invention have increased shear stability.

What is claimed is:

1. A method of preparing emulsions for emulsion polymerization comprising:
(i) providing an aqueous mixture of monomers,
(ii) adding one or more nonionic surfactants selected from the group consisting of:
(a) addition products of from 1 to 40 mol of ethylene oxide and/or propylene oxide per mole onto allyl alcohol, and
(b) addition products of from 1 to 40 mol of ethylene oxide and/or propylene oxide per mole onto allyl alcohol, where the OH group of these addition products is terminally capped in the sense that it is replaced by a group OR, where R is alkyl having 1 to 20 carbon atoms which may be saturated or unsaturated, straight-chain or branched; and
(iii) emulsifying the resulting mixture.

2. A method of producing aqueous latices by emulsion polymerization, comprising polymerizing the emulsion resulting from the method of claim 1.

3. The method of claim 1, further comprising one or more surfactants selected from the group consisting of
(c) compounds of the formula R¹—O—X—R², where X is a moiety comprising 1 to 40 ethylene oxide and/or propylene oxide units linked together and in which R¹ and R², independently are alkyl having 1 to 20 carbon atoms which may in each case be saturated or unsaturated, straight-chain or branched, with the proviso that R¹ and R² are not allyl,
(d) compounds of the formula R³—O—X—H, where X is a moiety comprising from 1 to 40 ethylene oxide and/or propylene oxide units linked together and in which R³ is an alkyl having 1 to 20 carbon atoms which may be saturated or unsaturated, straight-chain or branched, with the proviso that R³ is not allyl, and
(e) compounds of the formula H—O—X—H, where X is a moiety comprising 1 to 40 ethylene oxide and/or propylene oxide units linked together.

4. The method of claim 1 further comprising one or more surfactants selected from the group consisting of anionic and cationic surfactants.

5. The method of claim 2 wherein surfactants from groups (a) and/or (b) are used during and/or after the emulsion polymerization, and are further added to the formed latices for poststabilization.

6. The method of claim 1 wherein said monomers are selected from the group consisting of acrylic acid, acrylic acid esters, butadiene, methacrylic acid, methacrylic acid esters, styrene, vinyl acetate and vinyl versatate.

7. The polymer dispersion obtained by the method of claim 2.

8. A method of producing aqueous latices by emulsion polymerization, comprising polymerizing the emulsion resulting from the method of claim 3.

9. A method of producing aqueous latices by emulsion polymerization, comprising polymerizing the emulsion resulting from the method of claim 4.

10. The method of claim 3 further comprising one or more surfactants selected from the group consisting of anionic and cationic surfactants.

11. A method of producing aqueous latices by emulsion polymerization, comprising polymerizing the emulsion resulting from the method of claim 10.

12. The polymer dispersion obtained by the method of claim 8.

13. The polymer dispersion obtained by the method of claim 9.

14. The polymer dispersion obtained by the method of claim 11.
